(19) United States
(12) Patent Application Publication
(10) Pub. No.: US 2006/0004913 A1
(43) Pub. Date: Jan. 5, 2006

(54) System and method for inter-portlet communication

(76) Inventor: Kelvin Chong, San Jose, CA (US)

Correspondence Address: FAY KAPLUN & MARCIN, LLP, 15O BROADWAY, SUITE 702, NEW YORK, NY, 10038, US

(21) Appl. No.: 10/880,844

(22) Filed: Jun. 30, 2004

(51) Int. Cl. G06F 15/16

(52) U.S. Cl. 709/217

(57) ABSTRACT

Described is a method for transmitting data between portlets including creating a list of data structures including information for a plurality of portlets which are displayed on a web page, generating transmission data including information destined for at least one of the portlets, searching the list of data structures for the at least one of the portlets, returning a unique identification of the at least one of the portlets and transmitting the transmission data to the at least one of the portlets.

### BACKGROUND OF THE INVENTION

Many websites today attempt to attract and keep a larger audience by serving as portals to vast arrays of information, resources and services. It would not be unusual to find a search engine, the local weather report, email, on-line shopping malls and more packaged together in a single Web page. These distinct functionalities are usually divided into individual portlets that, although running simultaneously, are transparent to the rest. That is, the actions and characteristics of one portlet are independent from and will have no bearing on any of the other portlets.

Sometimes communication between different portlets may be desirable. For example, portals often conveniently enable several portlets to identify a user from one login screen. Currently, portlets share information by establishing or changing global variables that are visible to other portlets. A problem, however, occurs when a portlet needing that information completed execution prior to that information being available.

### SUMMARY OF THE INVENTION

A method for transmitting data between portlets including creating a list of data structures including information for a plurality of portlets which are displayed on a web page, generating transmission data including information destined for at least one of the portlets, searching the list of data structures for the at least one of the portlets, returning a unique identification of the at least one of the portlets and transmitting the transmission data to the at least one of the portlets.

In addition, a system comprising a plurality of portlet applications displayed on a page and a list of data structures, each data structure including information corresponding to one of the portlet applications, wherein a first one of the portlet applications searches the list of data structures for a second one of the portlet applications and sends a message to the second portlet application using a unique identification of the second portlet application.

Furthermore, a portlet application, comprising a generation element configured to generate a message to be transmitted to a second portlet application, a searching element configured to search a list including information corresponding to a plurality of portlet applications, the second portlet application being one of the plurality of portlet applications and a transmission element configured to transmit the message to the second portlet application.

### BRIEF DESCRIPTION OF THE DRAWINGS

FIG. 1 shows an exemplary embodiment of a Web portal according to the present invention.

FIG. 2 shows an exemplary embodiment of coexistent portlet applications with inter-portlet communication APIs according to the present invention.

FIG. 3 shows an exemplary process for implementing inter-portlet communication according to the present invention.

### DETAILED DESCRIPTION

The present invention may be further understood with reference to the following description and the appended drawings, wherein like elements are provided with the same reference numerals. The present exemplary embodiment is described with reference to portlets which are implemented using the Java Specification Request (“JSR”) 168 Portlet Specification standard. However, those of skill in the art will understand that the present invention may be implemented in such a manner as to allow communication between portlet applications regardless of the implementation of the portlets.

By defining a set of Application Programming Interfaces (“APIs”) and setting guidelines for portlet personalization, presentation and security, JSR 168 provides a common infrastructure from which programmers may create portlet applications that are interoperable between different portals. Various applications adhering to the standard are able to coexist and be interchanged on the same Web page, even where the portlet applications are produced by different vendors.

Although JSR 168 goes a long way to standardize the creation of portlets, it nonetheless lacks a set of guidelines for communication between the portlets. The exemplary embodiments of the present invention described herein provide an efficient method for exchanging information across a wide range of portlet applications without the need for global variables. A new set of APIs are added to facilitate data transmission to coexisting portlets. To determine the proper recipients, the sender portlet scans the properties of the other coexistent portlet applications. The information is then dispatched and portlets with new content are promptly refreshed.

In order to facilitate understanding of the present invention, throughout this description an example of identifying a portal's visitor from a single login screen will be used. Login will be accomplished through a portlet providing email functionalities and will require a username and password. From these two pieces of input, the other portlets can gain access to information regarding the user from a stored database. The portlet that dispatches information will be referred to as the sender portlet, and the portlet that receives information will be referred to as the destination portlet. It is to be understood that this description is only exemplary and that inter-portlet communication may take many other forms.

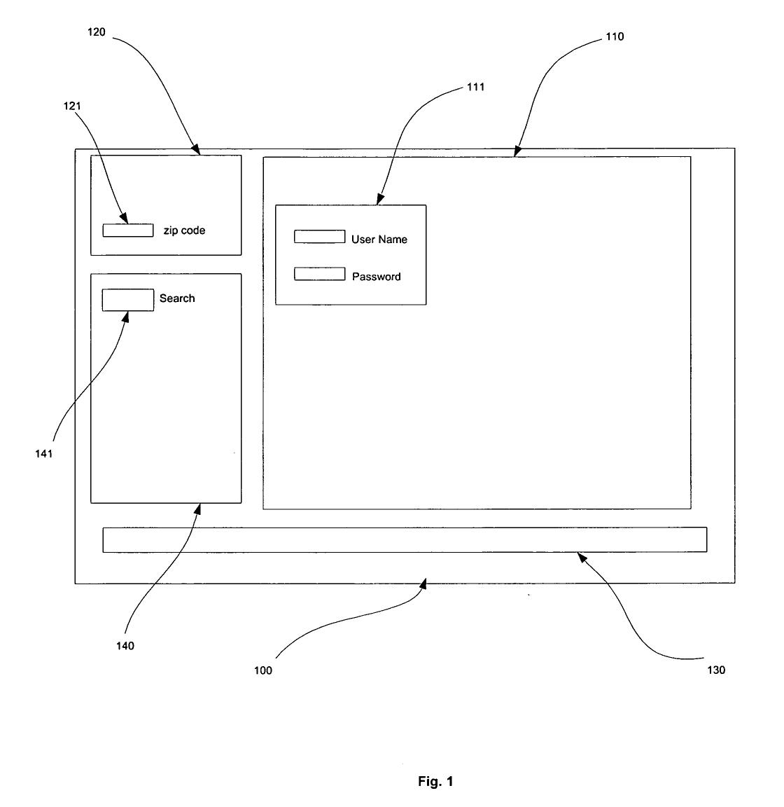

FIG. 1 shows an exemplary embodiment of a Web portal 100 with several functionalities. Each functionality is an independent portlet application simultaneously occupying a predetermined segment of the Web page and is in compliance with the JSR 168 standard. The email portlet 110 is an application which, after a visitor enters user and password information into prompt 111, displays the visitor's emails and provides email functionalities. The weather portlet 120 returns the weather corresponding to a zip code entered by a visitor into the prompt 121. Alternatively, the weather portlet 120 may retrieve the visitor's zip code from a database after user information is obtained from the email portlet 110. The news ticker portlet 130 scrolls headlines across the Web page that are linked to other pages containing the entire news article. The shopping portlet 140 allows a visitor shop online, e.g., to browse categories of goods offered by on-line vendors and to perform searches for specific items entered into the prompt 141.

Although the foregoing exemplary embodiment shows only a single instance of any one application, multiple concurrent instances may also be implemented. For example, after a zip code is supplied to the prompt 121, the weather portlet 120 may display an extended 5-day forecast rather than simply the current conditions. The forecast for each day may then be a separate occurrence of the same application that retrieves weather information from a remote source. To differentiate between the five instances, a unique instance ID may be assigned to each instance.

The web portal 100 and the foregoing description are not to be construed so as to limit the present invention in any way. As will be apparent to those skilled in the art, the combinations of different types of portlets and their placement within a Web page are unlimited. The portlets 110, 120, 130 and 140 are only exemplary and represent a small fraction of the portlet applications available today. Other applications provide functionalities that include but are not limited to email, instant messaging, forums, and stock quotes.

In a more specific example, the Web page may represent a user interface designed for the monitoring and control of a wireless network. The various portlets may have applications which, for example, monitor attributes of wireless devices, monitor network attributes, allow for remote configuration of devices, etc. A system administrator may desire to use the different portlet applications for the purpose of maintaining the wireless network at its optimum performance. To accomplish this goal, the different portlet applications may exchange information.

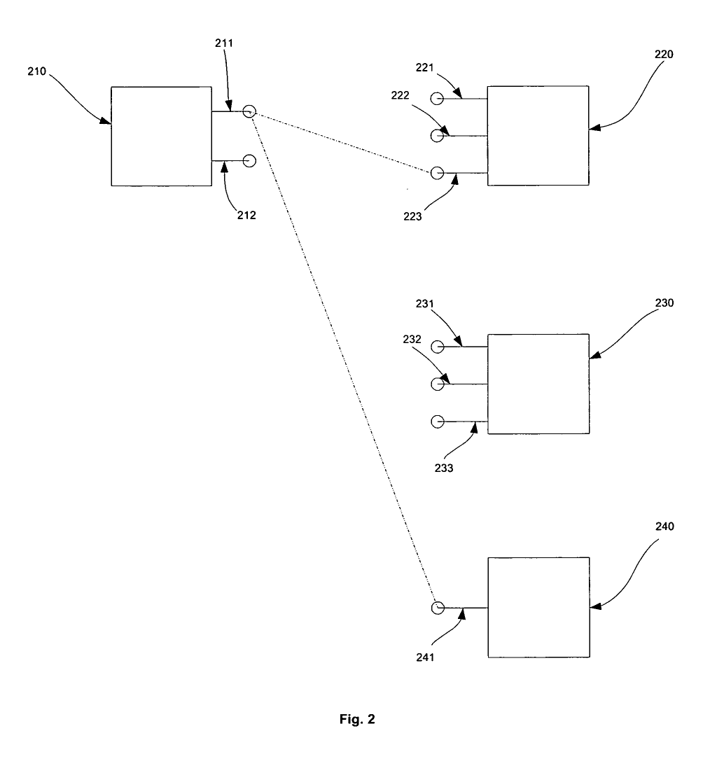

FIG. 2 shows an exemplary embodiment 200 of coexistent portlet applications with exposed APIs. For purposes of illustration, the objects depicted in FIG. 2 represent the portlets of FIG. 1, such that the object 210 represents the portlet 110, the object 220 represents the portlet 120, the object 230 represents the portlet 130, and the object 240 represents the portlet 140. Each object includes components such as JSR 168 APIS, functions, parameters, variables, and anything else comprising a portlet application.

Each object exposes selected APIs with which other objects may interact. The internal components of the objects remain hidden as only the interfaces are exposed. The exposed APIs 211-212, 221-223, 231-233, and 241 appear as exposed extensions to the objects 210, 220, 230 and 240, respectively. Because they are exposed, these APIs are visible to all objects in the portlet container. In practice, they are a set of functions or subroutines that interact with each other to perform the operations necessary for information transfer between the different objects. API 211 of object 210 is shown communicating with API 223 of object 220 and API 241 of object 240.

In the example of FIG. 2, each of the objects 210, 220, 230 and 240 will have a JSR 168 API exposed. The present invention allows for the extension of these JSR 168 APIs, thereby implementing the functionality associated with the present invention, but not breaking the standard to which the portlets are written, e.g., JSR 168. The searching functionality which will be described in greater detail below may be implemented by extending the JSR 168 “ActionRequest” and/or “ActionResponse” APIs. The messaging functionality which will also be described in greater detail below may be implemented by extending the JSR 168 API with a “sendmessage” function.

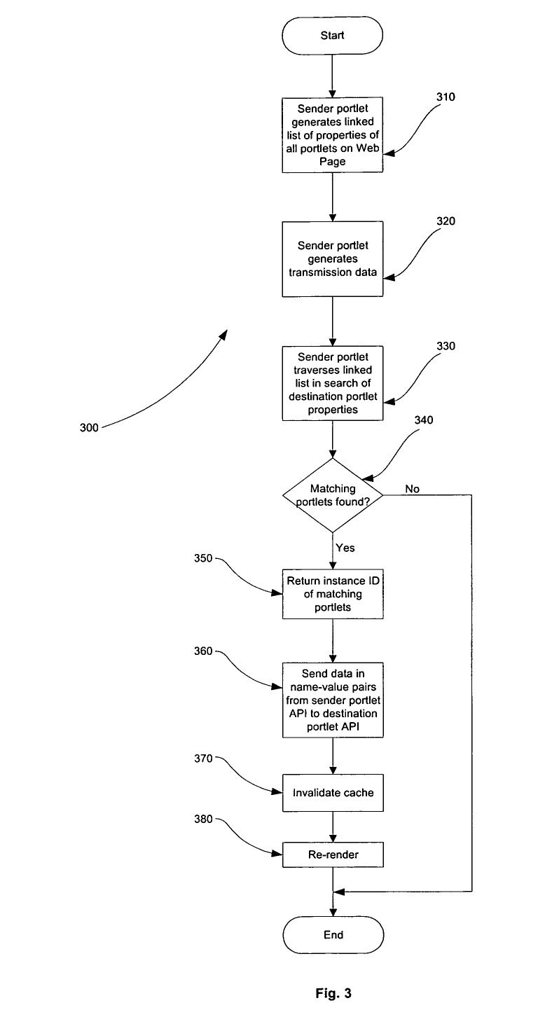

FIG. 3 shows an exemplary process 300 for implementing inter-portlet communication. In step 310, a discovery mechanism comprising a series of APIs that perform searching operations creates a linked list of data structures representing the entire Web page. Each node in the list represents a portlet application currently executing on the page. Within each node is an assortment of information regarding the portlet. All information is searchable so that portlets with specific properties may be isolated as targets for data transfer.

Thus, referring to the exemplary Web portal 100 of FIG. 1, in step 310 the list may contain four interconnected nodes corresponding to the four portlets 110, 120, 130, and 140. Each node may further contain information regarding the portlet that it represents. The inter-portlet communication APIs determine the type of information contained in each node. For example, the properties returnable through these APIs include a portlet's unique instance ID (“getInstanceID”), its name (“getPortletName”), its window state (“getWindowState”), its mode (“getPortletMode”), its host Web application name (“getWebAppName”), its content (“fetchContent”) and a timestamp of when the content was last updated (“getLastUpdate”). Additionally, developer-supplied information may be returnable, including any titles (“getTitle” and “getShortTitle”), descriptions (“getDiscription”) and keywords (“getKeywords”).

Referring back to the exemplary process 300, in step 320 the transmission data is generated. This data may be as simple as user input from a prompt, such as the username and password. However, this information would be of no immediate use to the destination portlets, and the destination portlets will then have to retrieve from a database the appropriate user information. The weather portlet 120 and the news ticker portlet 130, for example, would need to obtain the user's zip code after being sent a username before displaying the local weather and news. Alternatively, the sender portlet itself may retrieve the appropriate information or perform some type of computation on the user input prior to dispatch.

In a next step 330, the sender portlet utilizes a discovery mechanism to perform a search for the proper destination portlets. Due to portlet interoperability under the JSR 168 standard and the abundance of portlet suppliers, a simple search for target portlet names is insufficient. Instead, the discovery mechanism traverses the linked list created in step 310 and examines the properties of all portlets currently being displayed. Target portlets are those with properties related to the transmission data. For example, were a user's address to be dispatched, it may be desirable to seek portlets that concern local affairs or have as input a zip code. Thus, in the exemplary embodiment of FIG. 1, the weather portlet 120 and the news ticker portlet 130 may be designated by the discovery mechanism as targets for address information. Similarly, the shopping portlet 140 may be designated the intended recipient of information regarding the user's previous on-line purchases.

The searching mechanism of the present invention allows for a loosely coupled system. In such a system, a portlet will not break should another portlet not be available on the page. It also allows for wildcard searches where a portlet may broadcast a message to a variety of portlets that satisfy one or more of the search criteria.

In a next step 340, the sender portlet determines whether any matches were found by the discovery mechanism. If there were no matches, the process ends and no inter-portlet communication is necessary. On the other hand, if matches were found, the process continues to step 350 where the unique instance ID of the destination portlet is returned.

In a next step 360, the transmission data is dispatched to the portlets corresponding to the to the unique instance IDs stored in the previous step. In furtherance of its goal to create a uniform portlet standard, JSR 168 stipulates that all parameters be specified as name-value pairs. Accordingly, in this exemplary process the transmission data is first translated into one or more name-value pairs prior to dispatch. One advantage afforded by this is that information being passed from one portlet to another will appear as if it originates from within the destination portlet itself. An example of a name-value pair is “zip_code=12345.” However, as described above, the present invention is not limited to portlets implemented using the JSR 168 standard and therefore the data will be dispatched based on the specific implementation of the portlets.

Continuing with the exemplary process 300, in step 370 the cache of the destination portlet is invalidated. Under the JSR 168 standard, each portlet has a cache in which its contents for display are stored and a flag to disclose whether that cache is currently valid. Every time a portlet's contents are changed, the cache is invalidated. Ordinarily, at the expiration of a predetermined “timeout” period, if the cache is invalid the JSR 168 “render( )” function is called to re-render the portlet's display on the Web page. However, since data transmission between portlets will invariably alter the contents of the destination portlet, re-rendering may take place immediately after inter-portlet communication is complete. Therefore, in step 380, the “render( )” function is called, after which the portlet display is updated and the exemplary process 300 is complete.

It should be noted that in a preferred embodiment all inter-portlet communications occur before any rendering occurs. This ensures that all processing is complete prior to rendering. Once rendering occurs, it may not be possible to re-render a previously rendered portlet within the same transaction. For example, in the case of a browser, the content is sent serially to the browser such that once portlet content is sent, it cannot be withdrawn for updating. Therefore, all the inter-portlet communications take place to avoid redundant rendering of portlets and to avoid maintaining buffers for the content in addition to the caches previously described.

The present invention has been described with the reference to the above exemplary embodiments. One skilled in the art would understand that the present invention may also be successfully implemented if modified. Accordingly, various modifications and changes may be made to the embodiments without departing from the broadest spirit and scope of the present invention as set forth in the claims that follow. The specification and drawings, accordingly, should be regarded in an illustrative rather than restrictive sense.

What is claimed is:

1. A method, comprising the steps of:
creating a list of data structures including information for a plurality of portlets which are displayed on a web page;
generating transmission data including information destined for at least one of the portlets;
searching the list of data structures for the at least one of the portlets;
returning a unique identification of the at least one of the portlets; and
transmitting the transmission data to the at least one of the portlets.

2. The method of claim 1, further comprising the step of:
rendering the at least one of the portlets.

3. The method of claim 2, wherein the rendering step includes the substep of:
invalidating a cache of the at least one portlet.

4. The method of claim 1, wherein the list is a linked list.

5. The method of claim 1, wherein the information in the data structures includes one of a unique instance identification, a name, a window state, a mode, a host application name, content and a timestamp.

6. The method of claim 1, wherein the information in the data structures is supplied by a user and includes one of a title, a description and a keyword.

7. A system, comprising:
a plurality of portlet applications displayed on a page; and
a list of data structures, each data structure including information corresponding to one of the portlet applications, wherein a first one of the portlet applications searches the list of data structures for a second one of the portlet applications and sends a message to the second portlet application using a unique identification of the second portlet application.

8. The system of claim 7, wherein the second portlet application is rendered after receiving the message.

9. The system of claim 7, wherein the plurality of portlet applications are implemented using a JSR 168 standard.

10. The system of claim 7, wherein the message includes information entered by a user into the first portlet application.

11. The system of claim 10, wherein the first portlet application searches the list of data structures at least partially based on the information entered by the user.

12. The system of claim 7, wherein the list of data structures is a linked list.

13. The system of claim 7, wherein the plurality of portlet applications is operated for monitoring and controlling of a wireless network.

14. The system of claim 7, wherein the information in each of the data structures includes one of a unique instance identification, a name, a window state, a mode, a host application name, content and a timestamp.

15. The system of claim 7, wherein the message is transmitted using a name-value pair scheme.

16. A portlet application, comprising:
a generation element configured to generate a message to be transmitted to a second portlet application;
a searching element configured to search a list including information corresponding to a plurality of portlet applications, the second portlet application being one of the plurality of portlet applications; and
a transmission element configured to transmit the message to the second portlet application.

17. The portlet application of claim 16, further comprising:
a list generation element configured to generate the list of information for each of the plurality of portlet applications.

18. The portlet application of claim 16, wherein the message is transmitted using name-value pairs.

19. The portlet application of claim 16, wherein the searching element returns a unique identification for the second portlet application when it is found in the list.

20. The portlet application of claim 19, wherein the transmission element uses the unique identification of the second portlet application for transmitting the message.
